(19) United States
(12) Patent Application Publication
(10) Pub. No.: US 2012/0216436 A1
(43) Pub. Date: Aug. 30, 2012

(54) Traffic Control Sign and Communication System

(76) Inventor: Lorraine Adair, Elmira, NY (US)

(21) Appl. No.: 13/355,640

(22) Filed: Jan. 23, 2012

Related U.S. Application Data
(60) Provisional application No. 61/446,131, filed on Feb. 24, 2011.

(51) Int. Cl. G09F 13/02; G09F 27/00; G09F 25/00

(52) U.S. Cl. 40/559

(57) ABSTRACT

An illuminated construction traffic control system comprising a handheld sign having a first and second side, a two-way communication system for relaying audio signals between paired signs, a power means for illuminating a lighted portion on both sides of the sign and a post for supporting the sign and allow ease of sign rotation. An illuminated indicator light is provided on the sign to correspond with standard traffic light signals and text on the sign to improve clarity for motorists in low light and bad weather conditions, while an attached radio improves coordination between paired construction crew personnel directing traffic through a construction site. Power is provided via an external generator or imbedded battery power for more independent operation. Radio communications function on a radio frequency or similar wireless link between paired signs, wherein audio transmission and receiving is provided.

### CROSS REFERENCE TO RELATED APPLICATION

This application claims the benefit of U.S. Provisional Application No. 61/446,131 filed on Feb. 24, 2011, entitled “Safety Lights on Construction Site Signs.”

### BACKGROUND OF THE INVENTION

1. Field of the Invention

The present invention relates generally to construction signs and safety equipment. More specifically, the present invention relates to traffic control signs and communication systems between construction crew sign holders to coordinate and control the flow of traffic through a construction site and to regulate the speed of vehicles therethrough while providing a more readily apparent means of traffic signaling, even in low light or poor weather conditions.

Controlling traffic through a roadway construction site is of primary importance as it relates to worker and motorist safety, particularly where construction crews are operating in a high traffic area. Vehicles attempting to pass through the construction site must yield to crew traffic control personnel (flagger) directions and lower their speed to reduce incidents of traffic collisions with construction equipment, personnel and other motorists. Generally, flaggers are posted at the entrance and exit of a road construction site to direct traffic entering and traveling through the site. These individuals must coordinate to control the flow of traffic, particularly if a single lane is available for vehicles to traverse the site. Halting traffic from one direction and allowing another to pass through requires coordination and effective communication between flaggers and pedestrian vehicles, as well as communication between paired flagger teams. If a miscommunication occurs, two cars may enter a site from opposing directions, raising the probability of a traffic collision or at the very least a delay in the process of allowing traffic to flow smoothly through the site.

Communication between construction personnel and traveling motorists is most often coordinated using visual, handheld signs that direct a motorist to take an action or direction through a site. These signs are generally controlled by flagger personnel and comprise large, two-sided panels of a vibrant color with the text “SLOW” or “STOP” on respective sides to either allow traffic to slowly enter the site or to stop traffic at the site entrance. In the instance of a single throughway, a first flagger will halt incoming traffic by directing the “STOP” side of the sign at incoming vehicles. After the throughway is clear of any vehicles, a second flagger allows incoming traffic from an opposing direction by facing the “SLOW” side of the sign towards incoming vehicles. In this way, traffic is allowed to flow through the site at one direction at a time, whereafter the flow can be stopped and restarted from an opposite direction so as not to back up traffic along a roadway unnecessarily on either side of the site, while still allowing construction crews to work on a portion of the roadway or bridge with relative safety. The flow of traffic and the speed thereof is controlled and carefully coordinated between flagger personnel. It is therefore paramount that this communication be clear, coherent and efficient with regard to direction to motorists and having flagger personnel coordinate appropriate commands in harmony. Ineffective communication can expose construction workers and motorists to safety hazards and potential injury.

Communication between flaggers generally comprises radio communication or hand signals to change the flow of traffic or coordinate a desired traffic pattern. This requires the flaggers to either speak or gesture to one another to ensure a coordinated direction for traveling motorists to obey. Miscommunication and conflicting signals can result in dangerous situations and site accidents, which compromises the safety of all those involved. This communication risk is exacerbated if flaggers are posted a great distance from one another, or if radio communication is the only means of coordination. Weather and distance can reduce the viability of any visual cues between workers, which makes reliance on a coordinated communication system of prime importance. Generally workers employ a handheld two way radio or similar communication system that is separate from the signs, requiring the user to control the sign with one hand and communicate with another.

2. Description of the Prior Art

There are current drawbacks to currently utilized traffic control signs and associated systems that utilize passive signs and separated communication systems between coordinating flag workers. Low light environments, poor weather conditions and other poor visibility scenarios severely limit the effectiveness of passive signs. Separated communication systems from the signs put into question the ability of that system to reach its intended recipient and the efficiency of the system. The present invention provides a solution to these drawbacks by providing an illuminated signal system that provides very clear direction to motorists at a construction site in all weather and visibility conditions, while also providing an imbedded communication system within the sign to improve coordination between teaming flaggers directing traffic through a site, and one that does not require a stand-alone communication means to operate. The sign comprises both features into one device, improving worker efficiency and efficiency of the traffic control system as a whole.

Several devices have been disclosed that attempt to solve the drawback of reduced sign clarity in low light or bad weather. These devices employ similar design features for the purposes of creating an illuminated sign, including those that provide auxiliary lighting means for illuminating the indicia printed on a sign, those that provide illumination in a desired pattern to highlight the desired sign command, and finally those that provide cut-outs or patterns to project imbedded light from within the sign. These devices provide novel means of highlighting a handheld sign, but fail to provide a means to communicate between a pair of signs, as provided by the present handheld sign and communication system.

Specifically, U.S. Pat. No. 5,276,424 to Hegemann is one such disclosure that describes a handheld sign having printed text and a shape adapted to communicate common roadway directions, along with at least two lights to illuminate the sign during operation. The lights may stay illuminated continuously or provide a flashing capability, wherein the lights are powered by a rechargeable battery pack that can be recharged via several common power generation means. A switch on the sign handle provides control over the functionality of light for a user to operate. The lighted portion of the sign, however, does not provide any suggestive pattern or illuminate in a fashion similar to traffic light signals, but rather it illuminates a bright light to highlight printed text placed on the sign itself. Flashing, misplaced or haphazardly chosen lights may cause confusion at night as to the shape of the sign and the intended signal, which should be obvious given the shape of the sign and the color of the illumination means, whereafter the text is read. Further, the Hegemann device does not solve the problem of poor communication between paired sign holders, as provided by the present invention.

Similar to the Hegemann disclosure is U.S. Patent Application Publication Number 2006/0061487 to Heap, in which a portable, handheld traffic signal is provided wherein an indicia-bearing sign is enhanced by electrically powered sources of illumination along the periphery of the sign. A power source provides power for the illumination, which highlights the text written on the sign. This disclosure follows a similar structure and drawback of the Hegemann patent, wherein errand illumination may detract from the sign's shape while operating in low light conditions. Communication and obvious illuminating features are not provided by the Heap disclosure, which is provided for in the present invention.

U.S. Pat. No. 7,233,259 to Gibson is another device that describes a traffic control sign assembly that comprises a shaped sign having a central opening. The central opening houses a two-sided bread board type LED panel with light diffusing panels mounted over the panel exterior. A first and second silk screen provides for the text “STOP” and “SLOW” on a first and second side of the sign for creating an illuminated traffic control sign. An imbedded power source provides power while a power switch controls the device operation. While providing a unique means to illuminate text on a sign, no means of communication between paired signs is provided, reducing the communication efficiency of the Gibson device over the present invention.

Similar to the Gibson device is U.S. Patent Application Publication Number 2007/0209255 to Armwood, which discloses a handheld illuminated warning sign having a front and back translucent member having a predetermined color and warning indicia thereon. A light behind said translucent members and attached to the end of the handle provides illumination of the indicia for improved visualization purposes, while an onboard battery and switch provide power and control, respectively.

Finally, U.S. Pat. No. 6,198,410 to White, 6,204,777 to Lyons and 7,497,040 to Chambless all describe lighted construction or warning signs of similar structure, wherein a plurality of LEDs or similar illumination means provide an outline of the desired indicia on the handheld sign. The light provides improved visualization, while the pattern of the lights and color thereof provide an unmistakable reference in low light and poor weather conditions. These devices have similar design elements for a shared purpose, but fail to disclose the structure and intent of the present sign, which is an advanced sign communication device and system that improves the sign's ability to warn motorists while also providing improved communication and coordination between paired sign holders while in operation.

The present device improves construction safety by improving communication between and from sign holders controlling the flow of traffic incoming and outgoing through a roadway construction area in all weather and light conditions. The elements of the device and the spirit of the present disclosure substantially diverges in design elements from the prior art and consequently it is clear that there is a need in the art for an improvement to existing construction sign equipment and communication devices. In this regard the instant invention substantially fulfills these needs.

### SUMMARY OF THE INVENTION

In view of the foregoing disadvantages inherent in the known types of construction signs and communication systems now present in the prior art, the present invention provides a new sign and system wherein the same can be utilized for providing convenience for the user when controlling the flow of traffic through a roadway construction site in any weather or light conditions.

It is therefore an object of the present invention to provide a new and improved construction sign and communication device that has all of the advantages of the prior art and none of the disadvantages.

Another object of the present invention to provide a handheld construction sign that comprises an illumination means that follows the same pattern as a traffic light (yellow for slow, red for stop) on a respective first and second face, combined with a sign that provides an obvious shape and indicia for the intended signal, wherein the sign is utilized to direct the flow of traffic by rotating the sign towards an intended target motorist.

Another object of the present invention is to provide a handheld construction sign that is capable for providing direction for inflowing motorists in dim light and harsh weather conditions, wherein the signals are illuminated such that the directions are intuitive and readily visible.

Yet another object of the present invention is to provide a handheld construction sign with an imbedded communication system such that a paired set of signs allows direct audio communication between workers coordinating the flow of traffic through a roadway construction site, independent of visual cues and requiring no third party or external communication means to be utilized in conjunction with the handheld sign.

Still yet another object of the present invention is to provide a handheld construction sign that can be powered by a generator or via battery power for prolonged use or more independent operation.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal view of the first side of the present sign, wherein a STOP signal is shown and intuitively communicated via the sign pattern, indicia and illumination means.

FIG. 2 shows a frontal view of the second side of the present sign, wherein a SLOW signal is shown and intuitively communicated via the sign pattern, indicia and illumination means.

FIG. 3 shows a close-up view of the present sign communication means and control features of the sign.

FIG. 4 shows an example situation in which the present construction sign and communication system may be implemented, wherein two paired flagger personnel are positioned a distance apart and in poor weather conditions.

### DETAILED DESCRIPTION OF THE INVENTION

Reference is made herein to the attached drawings. Like reference numerals are used throughout the drawings to depict like or similar elements of the present traffic control sign and communication system. For the purposes of presenting a brief and clear description of the present invention, the preferred embodiment will be discussed as used for improving construction sign signaling and communication for improved safety of workers and traveling motorists. The figures are intended for representative purposes only and should not be considered to be limiting in any respect.

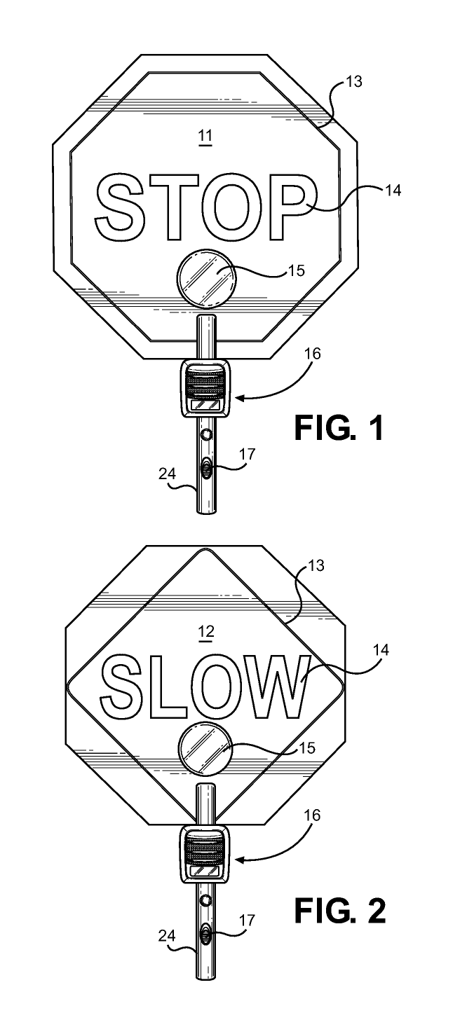

Referring now to FIG. 1, there is shown a frontal view of the first side 11 of the traffic control sign of the present invention. The sign itself is a panel having a first and second side wherein indicia 14 is provided thereon with an accompanying patterned border 13 that is indicative of the intended direction. On the first side 11 of the panel is written the text “STOP” for directing target motorists to halt and not pass the user holding up the signal. The patterned border 13 on the first side 11 of the sign is provided in the shape of a common traffic stop regulatory sign, or octagonal shape. The color of the panel is further indicative of the intended direction, wherein a red coloration within the border 13 is provided with white text and white edge periphery. The panel is adapted to be vibrant and align with regulatory requirements and standards with regards to color choice and shape. Below the sign is an attached handle 24 that is an elongated structure adapted to allow the user to hold the sign by hand or place the sign in connection with a post, such that the user is not required to support the sign and only control is orientation with respect to incoming traffic. The handle may further be provided as an elongated structure such that no attachment is necessary to allow the sign to be positioned at an elevated position and be supported by a ground surface.

Within the patterned border 13 of each panel side is an enlarged illumination means 15 that is adapted to illuminate a color that corresponds to the intended sign direction. On the sign first side 11 and corresponding to the “STOP” command, the illumination means provides a red light that is bright and vibrant such as would be provided in a traffic signal light. This allows the sign to be visible in low light and poor weather conditions, wherein the sign shape and indicia may otherwise be obscured or blurry from a motorist perspective. Along the handle 24 of the device is a light control switch 17 that allows the user to control the operation of the illumination means 15. When the switch 17 is placed in the on position, both the stop and slow light 15 is illuminated, allowing traffic to travel from one direction and be halted in another.

Below the sign and attached to the handle 24 is an attached two-way communication means 16. This device provides direct communication between paired signs and workers handling each sign. Workers may be positioned a great distance from one another, making hand gestures and visual cues impossible as a means of active communication while controlling traffic. To counter this situation, the communication means 16 allows each worker to communicate with one another as to when to allow motorists to enter and when to halt them in a given direction. In this way, the flow of traffic through a construction site is coordinated and carefully controlled.

Referring now to FIG. 2, there is shown a frontal view of the second side 12 of the traffic control sign of the present invention. This side of the sign is intended to provide direction for motorists to proceed forward in a slow manner, and to be wary of personnel working on the site. This side of the sign comprises the text “SLOW” written centrally thereon, accompanied by a border 13 that corresponds with a standard SLOW traffic sign, notably a rotated square or diamond pattern. The color of the sign within the border may be a bright yellow or orange coloration, depending on local DOT and regulatory requirements. Also within the border 13 is provided a corresponding illumination means 15 or signal light that illuminates a bright yellow. This light is adapted to conform to the yellow light of a standard traffic signal, which is used to slow motorists approaching an intersection with a traffic light. Similar to the first side, this light provide unequivocal notice to motorists as to the intentions of the sign and the directions being given by the flagger personnel. The second side of the handle 24 provides the same features and access to a two-way communication means 16 and control over the sign light. The light switch 17 may be accessible on both or either side of the handle, depending on the embodiment of the present invention. It is not desired to limit the design of the handle layout or of the layout of the light position on the sign, but rather it is intended to disclose several elements that comprise the scope and spirit of the present invention.

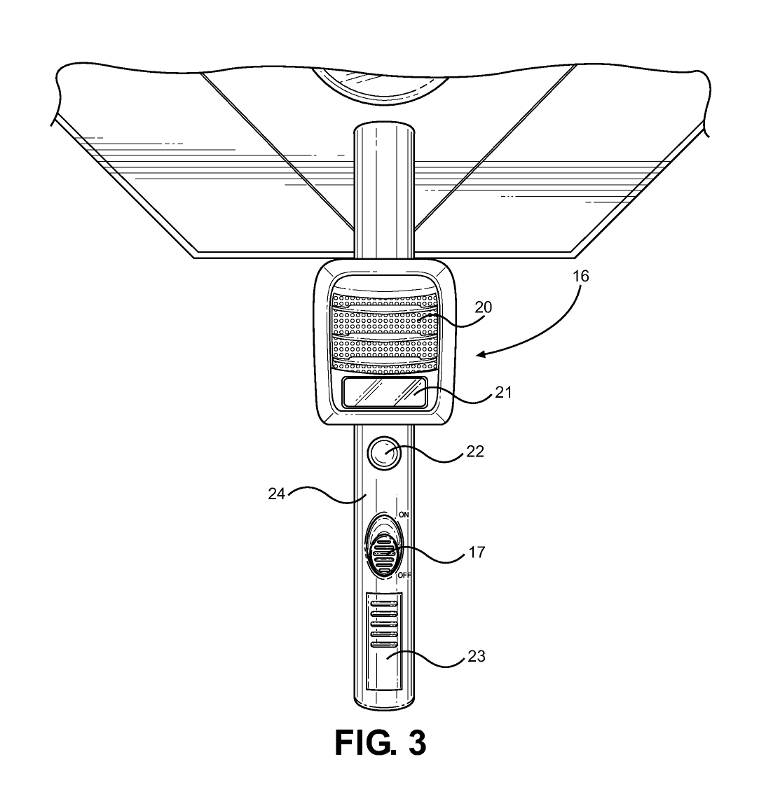

Referring now to FIG. 3, there is shown a close-up view of the communication system and handle of the present invention. The handle 24 connects to the sign and provides a means to control and handle the intended signals therefrom. Below the sign and attached to the handle 24 is a communication means 16, which comprises a two-way communication radio that utilizes radio waves or similar wireless pairing to transmit and receive audio signals from a second radio. The use of radio frequencies, as utilized by Bluetooth devices, two-way radios and push-to-talk devices allows a pair of users or plurality thereof to communicate audio signals to one another and direct a coordinated sign towards motorists. The radio comprises an audio output speaker and input microphone 20, along with an optional control panel display 21 and input controls to connect devices or choose a particular radio frequency to transmit and receive information. The user can input audio into the microphone, and thus communicate with paired devices using a talk button 22 provided below the radio 16, which is engaged for the period with which the user is speaking. Once released, the communication ends and another user may transmit audio. Alternatively, a more complex radio having full-duplex mode may be utilized, wherein transmission and receipt is possible simultaneously, as provided on cellular devices.

Below the radio 16 and talk button 22 is a light control switch 17 that allows the sign illumination means to light up for operation. The switch permit electrical current to flow from a power source and into the light, which may comprise a plurality of LEDs or incandescent lights, both of which projecting a bright, colored light such that the signal is transparent even in low light or poor weather. Power to the light and the communication system may be provided via onboard battery power 23, wherein several batteries may be input into the handle to power the assembly in a more independent fashion, wherein power lines and cords are eliminated. Alternatively, a cord extending from the handle 24 may be placed in connection with a generator for extended usage, if desired.

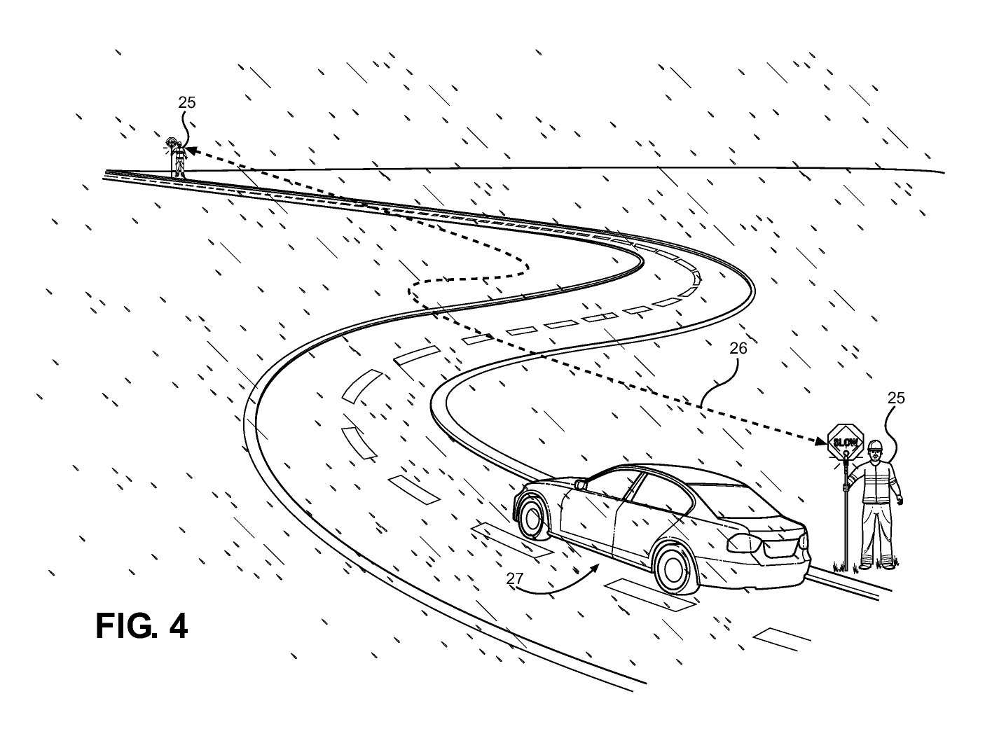

Referring now to FIG. 4, there is shown the present construction traffic sign and communication system of the present invention in a working position. The view shows an example environment wherein the present invention provides improved communication from workers to motorists, and between workers handling the flow of traffic. As shown, a first and second pair flagger 25 is positioned a distance apart along a roadway wherein traffic is being controlled. Each flagger 25 positions the sign of the present invention in a synchronized direction, such that traffic in a first direction are given one signal, and traffic in another direction are given another signal. A motorist 27 is directed to slowly traverse the controlled roadway by being shown the “SLOW” indicia on the sign second side, along with the corresponding light that provides very clear direction for the motorist, despite poor weather conditions. The distance between flaggers is overcome by utilizing the two-way communication system, wherein radio signals 26 are sent between flaggers to coordinate the control of traffic.

Overall, the present invention provides an improvement over existing traffic and construction signs by improving the clarity of the signal and improving the efficiency of traffic coordination. It is desired to disclose a pair of signs that are capable of pairing with one another to affect a means of communication between flaggers, and to provide a sign with an imbedded illumination means such that the sign is distinctly noticeable and its direction is clear, despite any weather conditions or low light environments. The lights correspond to the signal and conform to readily known traffic light signals, wherein red means stop and yellow means slow. Overall, it is a goal of the present invention to improve efficiency of traffic control and improve safety for all individuals involved, including construction crews, flaggers and motorists attempting to pass through a construction site.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A traffic control sign and communication system, comprising:
a sign having a first and second side, a handle, power means and two-way radio communication means;
said sign first side having a first border, first sign indicia, and an illumination means corresponding to said indicia instructions;
said sign second side having a second border, second sign indicia, and an illumination means corresponding to said indicia instructions;
a power switch for controlling operation of said illumination means.

2. The device of claim 1, wherein said first border further comprises an octagonal border and said first indicia states “STOP” instruction.

3. The device of claim 1, wherein said second border further comprises n rotated square border and said second indicia states “SLOW” instruction.

3. The device of claim 1, wherein said first side illumination means is red to correspond to said indicia instructions.

4. The device of claim 1, wherein said first side illumination means is yellow to correspond to said indicia instructions.

5. The device of claim 1, wherein said two-way radio communication means further comprises a speaker, microphone and speak button to allow communication between paired radios.

6. The device of claim 1, wherein said two-way radio further comprises a display and input controls pairing two or more radios and operating said sign radio.

7. The device of claim 1, wherein said power means further comprises imbedded battery power in said handle, providing power to operate said illumination means and said radio communication means.

8. The device of claim 1, wherein said power means further comprises a power cord extending from said handle and attaching to an external power source, providing power to operate said illumination means and said radio communication means.
